(19) United States
(12) Patent Application Publication
(10) Pub. No.: US 2025/0245678 A1
(43) Pub. Date: Jul. 31, 2025

(54) ABNORMAL BEHAVIOR DETECTION METHOD, ELECTRONIC DEVICE, AND STORAGE MEDIUM

(71) Applicant: Lenovo (Beijing) Limited, Beijing (CN)

(72) Inventors: Peijie LYU, Beijing (CN); Xiaoyi LIU, Beijing (CN)

(21) Appl. No.: 19/035,786

(22) Filed: Jan. 23, 2025

(30) Foreign Application Priority Data
Jan. 29, 2024 (CN) 202410121997.X

(51) Int. Cl. G06Q 30/018; G06F 16/901

(52) U.S. Cl. CPC G06Q 30/0185; G06F 16/9024

(57) ABSTRACT

An abnormal behavior detection method, an electronic device and a storage medium are provided in the present disclosure. The method includes obtaining behavior information, where the behavior information includes behavior information of at least two objects; constructing a behavior relationship graph according to the behavior information; based on one or more known abnormal nodes in the behavior relationship graph and a preset condition, determining an abnormal behavior subgraph in the behavior relationship graph, where the behavior information of the one or more known abnormal nodes is abnormal; and based on the abnormal behavior subgraph, determining an abnormal node in the behavior relationship graph.

### CROSS-REFERENCE TO RELATED APPLICATION

This application claims the priority of Chinese Patent Application No. 202410121997.X, filed on Jan. 29, 2024, the content of which is incorporated herein by reference in its entirety.

### TECHNICAL FIELD

The present disclosure generally relates to the field of data processing technology, and, more particularly, relates to an abnormal behavior detection method, an electronic device, and a storage medium.

### BACKGROUND

Abnormal behaviors such as insurance fraud and fake orders may occur in the market. Therefore, it is necessary to detect potential abnormal behaviors of customers or merchants to avoid losses.

### SUMMARY

One aspect of the present disclosure provides an abnormal behavior detection method. The method includes obtaining behavior information, where the behavior information includes behavior information of at least two objects; constructing a behavior relationship graph according to the behavior information; based on one or more known abnormal nodes in the behavior relationship graph and a preset condition, determining an abnormal behavior subgraph in the behavior relationship graph, where the behavior information of the one or more known abnormal nodes is abnormal; and based on the abnormal behavior subgraph, determining an abnormal node in the behavior relationship graph.

Another aspect of the present disclosure provides an electronic device. The electronic device includes a memory, configured to store a computer program; and one or more processors, configured to, when the computer program is executed, perform an abnormal behavior detection method. The method includes obtaining behavior information, where the behavior information includes behavior information of at least two objects; constructing a behavior relationship graph according to the behavior information; based on one or more known abnormal nodes in the behavior relationship graph and a preset condition, determining an abnormal behavior subgraph in the behavior relationship graph, where the behavior information of the one or more known abnormal nodes is abnormal; and based on the abnormal behavior subgraph, determining an abnormal node in the behavior relationship graph.

Another aspect of the present disclosure provides a non-transitory computer-readable storage medium, containing a computer program that when being executed, causes a processor to perform an abnormal behavior detection method. The method includes obtaining behavior information, where the behavior information includes behavior information of at least two objects; constructing a behavior relationship graph according to the behavior information; based on one or more known abnormal nodes in the behavior relationship graph and a preset condition, determining an abnormal behavior subgraph in the behavior relationship graph, where the behavior information of the one or more known abnormal nodes is abnormal; and based on the abnormal behavior subgraph, determining an abnormal node in the behavior relationship graph.

Other aspects of the present disclosure may be understood by those skilled in the art in light of the description, the claims, and the drawings of the present disclosure.

### BRIEF DESCRIPTION OF THE DRAWINGS

By referring to detailed description and accompanying drawings below, above- mentioned and other objectives, features and advantages of exemplary embodiments of the present disclosure may become easy to understand. In accompanying drawings, some embodiments of the present disclosure may be illustrated in an exemplary and non-restrictive manner. In accompanying drawings, same or corresponding reference numerals may represent same or corresponding parts.

FIG. 1 illustrates a flowchart of an abnormal behavior detection method according to various embodiments of the present disclosure.

FIG. 2 illustrates an exemplary behavior relationship graph according to various embodiments of the present disclosure.

FIG. 3 illustrates an exemplary behavior relationship graph with marked known abnormal nodes and suspicious nodes according to various embodiments of the present disclosure.

FIG. 4 illustrates an exemplary behavior relationship graph having an abnormal behavior subgraph according to various embodiments of the present disclosure.

FIG. 5 illustrates another exemplary behavior relationship graph having an abnormal behavior subgraph according to various embodiments of the present disclosure.

FIG. 6 illustrates another exemplary behavior relationship graph having an abnormal behavior subgraph according to various embodiments of the present disclosure.

FIG. 7 illustrates another exemplary behavior relationship graph having an abnormal behavior subgraph according to various embodiments of the present disclosure.

FIG. 8 illustrates a structural schematic of an abnormal behavior detection apparatus according to various embodiments of the present disclosure.

FIG. 9 illustrates a compositional structural schematic of an electronic device according to various embodiments of the present disclosure.

### DETAILED DESCRIPTION

The technical solutions in embodiments of the present disclosure are clearly and completely described below with reference to the accompanying drawings in embodiments of the present disclosure. Obviously, described embodiments are only a part of embodiments of the present disclosure, but not all embodiments. Based on embodiments in the present disclosure, all other embodiments obtained by those skilled in the art without creative efforts shall fall within the protection scope of the present disclosure.

Currently, insurance products may reduce consumers' risks and provide additional service value, thereby improving market competitiveness. However, while insurance brings convenience, there may be also some abnormal behaviors that deliberately obtain insurance compensation by providing false information or engaging in deceptive behavior. Detection of most abnormal behaviors may rely on the knowledge of business personnel by designing detection rules or inspection indicators. For example, in response to that same product is repaired many times within a certain period, the behavior may be considered to be suspicious abnormal behavior and needs to be manually re-verified. However, relying on the experience of business personnel may be not replicable and scalable, have relatively simple logic, and may not identify complex hidden abnormal behaviors. Or a model may be trained through a large amount of historical abnormal data or the weights of each feature, and the abnormal behavior may be predicted through the trained model. However, it may be impossible to design new features in the model, and the scalability of the model may be poor. Based on the above, the present disclosure provides an abnormal behavior detection method. It may be understood that the solution may also solve other abnormal behaviors such as click farming, which may be not limited to example scenarios.

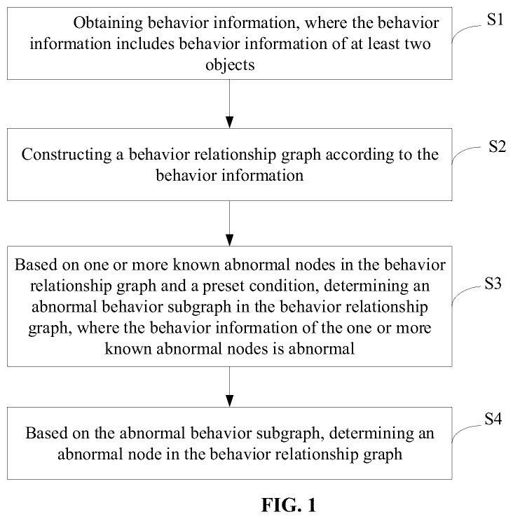

FIG. 1 illustrates a flowchart of an abnormal behavior detection method according to various embodiments of the present disclosure. The method may include following exemplary steps.

At S1, behavior information may be obtained, where the behavior information may include behavior information of at least two objects.

The objects may include individuals, organizations or entities involved in insurance transactions or related to insurance business such as users, maintenance stations, middlemen, devices, tickets and the like. For example, the objects may also include maintenance parts, suppliers, manufacturers, payment service providers and the like, which may be not limited in the present disclosure.

Taking the user being the object as an example, the user's behavior information may be the information provided by the user when purchasing a product and making a claim, including basic user information, location information, product usage, damage cause, maintenance record, claim history and the like.

The behavior information of the maintenance station may be the information provided by the maintenance station after receiving maintenance requests, including product test results, maintenance records, maintenance costs and the like.

The behavior information of the middleman may be the information provided by the middleman during the product sales process, including sales contracts, product warranty information, after-sales service records and the like.

The behavior information of the supplier or manufacturer may be relevant information about the products provided, such as product specifications, quality certification and the like.

Behavior information may be obtained through systems such as customer systems, ticket systems, insurance policy information systems, spare parts request systems, consumption systems, returned parts processing systems and the like. For example, the customer system may include information such as customer type, customer locations and the like. The ticket system may include information such as ticket numbers, ticket creation dates, ticket update dates, ticket corresponding devices, associated customers, repair stations creating tickets, and the like. The insurance policy information system may include information of the customer's purchase of the insurance policy. The spare parts request system may include information about the customer's request for spare parts, corresponding ticket numbers, and the like. The consumption system may include spare parts outbound information, logistics information, and the like. The returned parts processing system may include information about the return time, models, and specifications of returned parts, and the like.

At S2, a behavior relationship graph may be constructed based on the behavior information.

The behavior relationship graph may be configured to describe the interaction and information flow between objects and constructed through the behavior information between objects to show the interaction and dependency between objects.

At S3, based on one or more known abnormal nodes in the behavior relationship graph and a preset condition, an abnormal behavior subgraph in the behavior relationship graph may be determined, where the behavior information of the abnormal node may be abnormal.

In the behavior relationship graph, an abnormal node may refer to an object with abnormal behavior information. Known abnormal nodes may refer to objects that the behavior information may be inconsistent with the behavior pattern under normal circumstances. Known abnormal nodes may include known objects involved in fraud, false claims, illegal operations and the like. For example, in response to that a user is known to provide false claim information, the node represented by such user may be the known abnormal node in the behavior relationship graph. For another example, in response to that a maintenance station is known to provide false maintenance records, exaggerate or fabricate product damage to obtain higher maintenance costs, the node represented by the maintenance station may be also the known abnormal node in the behavior relationship graph.

The preset conditions may be configured to construct an abnormal node identification mechanism. One preset condition or a combination of multiple preset conditions may be set to identify abnormal nodes.

The manner of determining the abnormal behavior subgraph may be configured according to actual situation. For example, taking the abnormal node as the central node, the nodes within N hops outward from the central node may form the abnormal behavior subgraph. The abnormal behavior subgraph may also be a combination of adjacent subgraphs. Or by connecting the known abnormal nodes and other nodes that meet the preset condition, the subgraph containing abnormal nodes may be constructed, and such subgraph may represent the corresponding relationship between objects with abnormal behavior.

At S4, based on the abnormal behavior subgraph, the abnormal node in the behavior relationship graph may be determined.

Other abnormal nodes may be identified from the behavior relationship graph through the subgraph with known abnormal behaviors, thereby detecting more abnormal behaviors.

In above-mentioned solution of the present disclosure, by associating the behavior information of each object, the behavior relationship graph may be constructed to present the interaction and information flow between objects in a visual manner. Next, based on the known abnormal nodes in the behavior relationship graph and the preset condition, the abnormal behavior subgraph in the behavior relationship graph may be determined. Finally, the abnormal node in the behavior relationship graph may be determined according to the abnormal behavior subgraph. Compared with existing solutions, the solutions provided in the present disclosure may not rely on the experience of business personnel and the definition of behavior characteristics by business personnel, simultaneously analyze abnormal behaviors from the dimensions of multiple objects and may detect potential abnormal behaviors.

In one embodiment, constructing the behavior relationship graph according to the behavior information may include determining that the object of each behavior information is the node of the behavior relationship graph; and connecting objects with associated relationship as the edge of the behavior relationship graph.

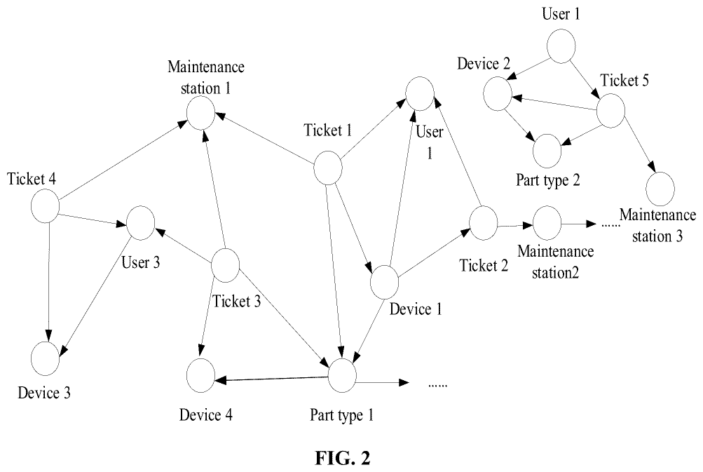

Referring to FIG. 2, FIG. 2 illustrates an example of the behavior relationship graph. The nodes (i.e., objects) in the behavior relationship graph may include users, maintenance stations, devices, tickets, and part types. In one embodiment, for example, the user 1 may be associated with the ticket 1 and the ticket 2, such that the user 1 may be connected to the ticket 1 and the ticket 2 respectively, and the connecting lines may be the edges of the behavior relationship graph.

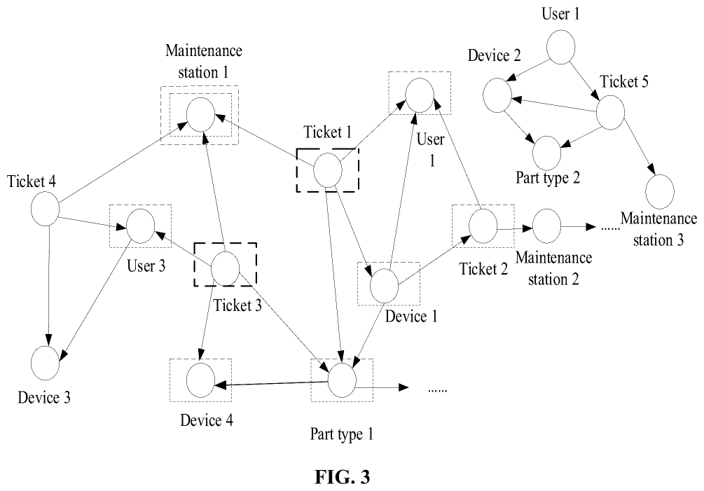

Known abnormal nodes may be marked in the behavior relationship graph. Assuming that the known abnormal nodes are the ticket 1 and the ticket 3, the ticket 1 and the ticket 3 may be marked in the behavior relationship graph. The marking symbols may be rectangular boxes, triangles, color markings and the like. As long as the marking symbols can be used for marking, the forms of the marking symbols in the present disclosure may be not limited. As shown in FIG. 3, the nodes marked by the thick-line rectangular box may be known abnormal nodes in the behavior relationship graph.

In one embodiment, the preset condition may include that in response to that a number of times, that the suspicious node in the behavior relationship graph is marked, satisfies a threshold, the suspicious node may be determined to be the abnormal node. The suspicious node may refer to a node that exhibits potential abnormal behavior in the behavior relationship graph.

In one embodiment, the suspicious nodes in the behavior relationship graph may include at least one of the following: determining a node, directly connected to the known abnormal node in the behavior relationship graph, to be the suspicious node; and/or determining a node, directly connected to a plurality of suspicious nodes, also to be the suspicious node.

Still taking above-mentioned behavior relationship graph as an example, since the ticket 1 and the ticket 3 are known abnormal nodes, the nodes directly connected to the ticket 1 may be marked as suspicious nodes; that is, the user 1, the device 1, the maintenance station 1, and the part type 1 may be suspicious nodes. The nodes directly connected to the ticket 3, such as the user 3, the device 4, the part type 1, and the maintenance station 1, may be also suspicious nodes. The marking symbol of the suspicious node may be different from the marking symbol of the known abnormal node. For example, the marking symbol of the known abnormal node may be a thick-line rectangular box, and the marking symbol of the suspicious node may be a thin-line rectangular box. The marking symbols may also be distinguished by color. For example, the node in the thin-line rectangular box shown in FIG. 3 may be a marked suspicious node.

For example, the node directly connected to two suspicious nodes may be also determined to the suspicious node. For example, in FIG. 3, the ticket 2 may be directly connected to both the user 1 and the device 1, so that the ticket 2 may be also determined to be the suspicious node.

In response to that the number of times, that the suspicious node in the behavior relationship graph is marked, satisfies the threshold, the suspicious node may be determined to be the abnormal node. Assuming that the threshold is set to 2, when the number of times, that the suspicious node is marked, is greater than or equal to 2, the suspicious node may be determined to be the abnormal node. For example, the maintenance station 1 is marked as the suspicious node twice, such that the maintenance station 1 may be determined to be the abnormal node.

In one embodiment, the preset (limiting) condition may be further configured. For example, determining a suspicious node may be determined as the abnormal node only when the number of times that the suspicious node is marked satisfies the threshold and the suspicious node is a specific object. For example, the specific objects may be configured as the user, the maintenance station, and the ticket. As shown in FIG. 3, the part type 1 is directly connected to the ticket 1 and the ticket 3, and the number of times that the part type 1 is marked as the suspicious node is also 2; however, the part type does not belong to the specific object, such that the part type 1 may be still the suspicious node, not the abnormal node.

In one embodiment, the preset condition may also be configuring an abnormal behavior frequency threshold. In response to that the abnormal behavior frequency of a node exceeds a preset threshold, the node may be determined as the abnormal node. The frequency may be the number of abnormal behaviors within a certain time window. For example, in response to that a user has more than 2 maintenance times within 1 week, the node where the user is located may be determined as the abnormal node.

In one embodiment, determining the abnormal behavior subgraph in the behavior relationship graph based on known abnormal nodes in the behavior relationship graph and the preset condition may include determining the abnormal node based on the preset condition; determining the abnormal node and the known abnormal node in the behavior relationship graph as intermediate nodes; and segmenting the behavior relationship graph according to the intermediate nodes to obtain an abnormal behavior subgraph in the behavior relationship graph.

Still in above-mentioned embodiments, the abnormal node determined according to the preset condition may be the maintenance station 1, and the known abnormal nodes may be the ticket 1 and the ticket 3. Therefore, the maintenance station 1, the ticket 1 and the ticket 3 may be used as intermediate nodes to segment the behavior relationship graph. For example, taking the intermediate node as the starting point, the behavior relationship graph may be traversed to gradually expand outward along the connection edges, and all nodes associated with the intermediate node may be added to the subgraphs, such that the behavior relationship graph may be segmented into multiple subgraphs with abnormal behaviors. For example, starting from the intermediate node, the subgraph including the nodes within 1 hop outward from the intermediate node may be determined as the abnormal behavior subgraph.

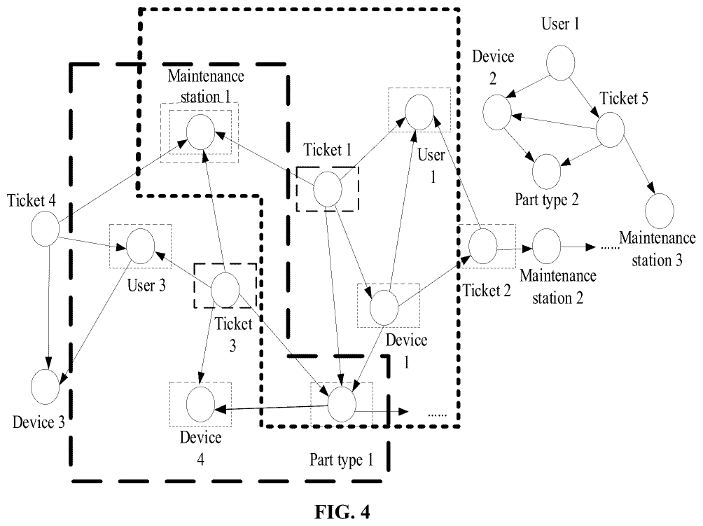

FIG. 4 illustrates an exemplary behavior relationship graph having the abnormal behavior subgraph according to various embodiments of the present disclosure. As shown in FIG. 4, for example, with the ticket 3 as the central node, the nodes within 1 hop outward from the central node and directly connected to the central node may be the maintenance station 1, the user 3, the device 4, and the part type 1. Therefore, the subgraph including the ticket 3, the maintenance station 1, the user 3, the device 4, and the part type 1 may be the abnormal behavior subgraph; and the nodes in the subgraph may be abnormal nodes.

For example, with the ticket 1 as the central node, the nodes within 1 hop outward from the central node and directly connected to the central node may be the maintenance station 1, the user 1, the device 1, and the part type 1. Therefore, the subgraph including the ticket 1, the maintenance station 1, the user 1, the device 1, and the part type 1 may be the abnormal behavior subgraph; and the nodes in the subgraph may be abnormal nodes.

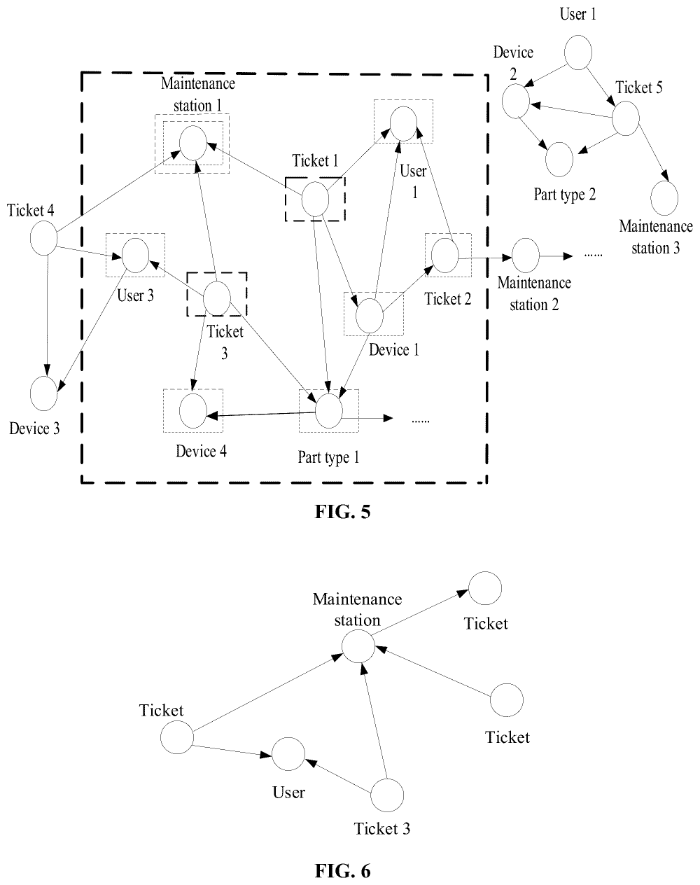

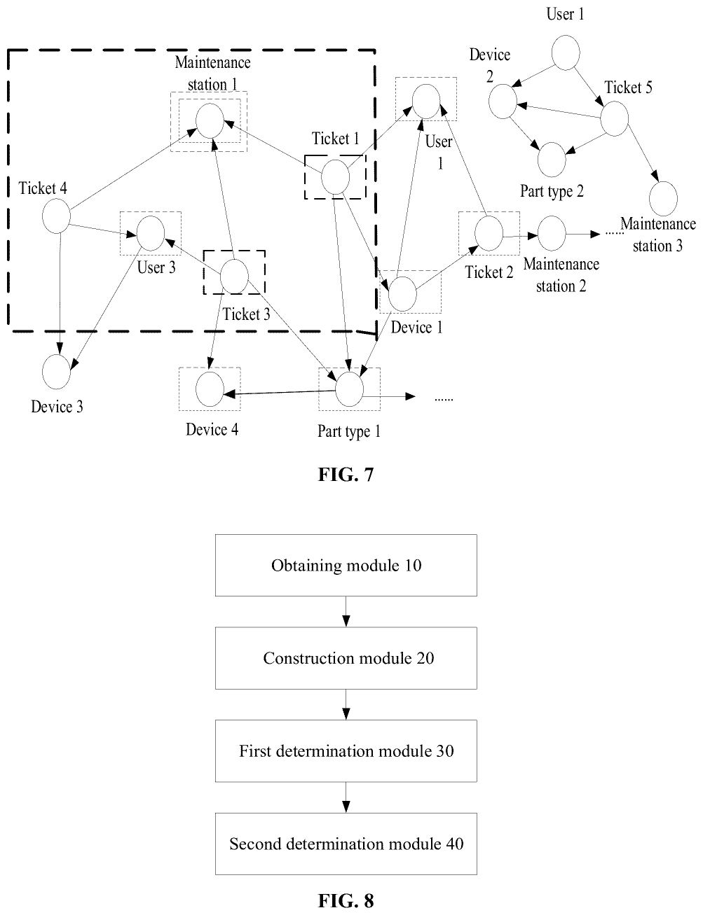

In one embodiment, the abnormal behavior subgraph may also be determined by other manners, such as combining known abnormal nodes and multiple newly determined abnormal nodes as the abnormal behavior subgraph. As shown in FIG. 5, the ticket 1 and the ticket 3 may be known abnormal nodes; and the maintenance station 1, the user 3, the device 4, the part type 1, the user 1, the device 1, and the ticket 2 may be newly determined abnormal nodes. Therefore, the subgraph including the ticket 1, the ticket 3, the maintenance station 1, the user 3, the device 4, the part type 1, the user 1, the device 1, and the ticket 2 may be determined as the abnormal behavior subgraph.

The nodes with the behavior relationship that occurred within a time duration may also be combined into a subgraph as the abnormal behavior subgraph. Certain key nodes may be also configured, and other nodes associated with the key nodes may be combined into a subgraph. For example, it is known that a maintenance station has multiple abnormal behaviors, the maintenance station may be configured as the key node, and other nodes associated with the key node may be combined into a subgraph, such that the subgraph may be determined to be the abnormal behavior subgraph.

In one embodiment, determining the abnormal node in the behavior relationship graph based on the abnormal behavior subgraph may include determining the first feature vector of the abnormal behavior subgraph; and selecting (e.g., by a matching process, or a comparing process, etc.) the abnormal node from the behavior relationship graph based on the first feature vector.

The features in the feature vector may include multiple features such as the number of nodes, the number of edges, node attributes, node relationships, subgraph densities, abnormal marks (such as whether there are known abnormal nodes in the subgraph) and the like; and above-mentioned data may be combined into the feature vector. The first feature vector of the abnormal behavior subgraph may also be directly extracted through a graph convolutional network (GCN).

In one embodiment, selecting abnormal node from the behavior relationship graph based on the first feature vector may include using the suspicious node in the behavior relationship graph as the central node, segmenting the behavior relationship graph to obtain a plurality of suspicious subgraphs; determining the second feature vector of each of the plurality of suspicious subgraphs; determining similarity between the first feature vector and the second feature vector; and determining a suspicious subgraph that satisfies a similarity threshold to be the abnormal behavior subgraph, where the suspicious node in the abnormal behavior subgraph is the abnormal node.

The behavior relationship graph may be same behavior relationship graph where the abnormal behavior subgraph is located or may be another behavior relationship graph (need to belong to same business field). Taking the suspicious node as the central node, multiple suspicious subgraphs may be determined using 1 hop outward approach mentioned above; and the second feature vector of each suspicious subgraph may be determined in same manner as the first feature vector. Subsequently, the similarity between the first feature vector and the second feature vector may be computed. For example, the similarity between the first feature vector and the second feature vector may be determined by cosine similarity, Euclidean distance and the like. Assuming that the similarity is determined by Euclidean distance, the smaller the similarity value is, the more the similarity between the first feature vector and the second feature vector is. In response to that the similarity threshold is set to 0.05, the suspicious subgraph corresponding to the similarity between the second feature vector and the first feature vector less than 0.05 may be determined as the abnormal subgraph; and the suspicious node in the abnormal subgraph may be the abnormal node. The setting of the similarity threshold may be configured according to the accuracy requirement and may be also determined according to different similarity calculation manners.

In one embodiment, the method may further include determining the abnormal node in the behavior relationship graph based on the known abnormal behavior subgraph.

The known abnormal behavior subgraph may be a known abnormal behavior pattern. First, the feature vector of the known abnormal behavior subgraph may be determined; next, the similarity between such feature vector and the second feature vector may be calculated; and then the abnormal node in the behavior relationship graph may be determined.

Furthermore, determined abnormal node may be used as the central node; the behavior relationship graph may be further segmented to obtain multiple subgraphs; the feature vectors of the subgraphs may be calculated; and the similarity between above feature vectors and corresponding feature vectors of known abnormal behavior (relationship) subgraph and determined abnormal behavior (relationship) subgraph may be calculated to detect new abnormal subgraphs and abnormal nodes.

For example, the known abnormal behavior subgraph is shown in FIG. 6, and the abnormal subgraph shown in FIG. 7 may be further detected based on the subgraph in FIG. 6.

According to embodiments of the present disclosure, the present disclosure further provides an abnormal behavior detection apparatus. The apparatus may include an obtaining module 10, configured to obtain behavior information, where the behavior information may include behavior information of at least two objects; a construction module 20, configured to construct the behavior relationship graph according to the behavior information; a first determination module 30, configured to, based on known abnormal nodes in the behavior relationship graph and the preset condition, determine the abnormal behavior subgraph in the behavior relationship graph, where the behavior information of the abnormal node may be abnormal; and a second determination module 40, configured to determine the abnormal node in the behavior relationship graph based on the abnormal behavior subgraph.

In one embodiment, the construction module 20 may be also configured to determine that the object of each behavior information is the node of the behavior relationship graph; and connect objects with associated relationship as the edge of the behavior relationship graph.

In an optional implementation manner, the preset condition may include that in response to that a number of times, that the suspicious node in the behavior relationship graph is marked, satisfies the threshold, the suspicious node may be determined to be the abnormal node.

In an optional implementation manner, the suspicious nodes in the behavior relationship graph may include at least one of the following: determining the node, directly connected to the known abnormal node in the behavior relationship graph, to be the suspicious node; and/or determining the node, directly connected to a plurality of suspicious nodes, also to be the suspicious node.

In an optional implementation manner, the first determination module 30 may be also configured to determine the abnormal node based on the preset condition; determine the abnormal node and the known abnormal node in the behavior relationship graph as intermediate nodes; and segment the behavior relationship graph according to the intermediate nodes to obtain the abnormal behavior subgraph in the behavior relationship graph.

In an optional implementation manner, the second determination module 40 may be also configured to determine the first feature vector of the abnormal behavior subgraph; and select the abnormal node from the behavior relationship graph based on the first feature vector.

In an optional implementation manner, the second determination module 40 may be also configured to, using the suspicious node in the behavior relationship graph as the central node, segment the behavior relationship graph to obtain a plurality of suspicious subgraphs; determine the second feature vector of each of the plurality of suspicious subgraphs; determine similarity between the first feature vector and the second feature vector; and determine the suspicious subgraph that satisfies the similarity threshold to be the abnormal behavior subgraph, where the suspicious node in the abnormal behavior subgraph is the abnormal node.

According to embodiments of the present disclosure, the present disclosure further provides an electronic device. The electronic device may include at least one processor; and a memory connected in communication with the at least one processor. The memory may store programs executable by the at least one processor. The programs may be executed by the at least one processor to enable the at least one processor to execute: obtaining behavior information, where the behavior information includes behavior information of at least two objects; constructing a behavior relationship graph according to the behavior information; based on one or more known abnormal nodes in the behavior relationship graph and a preset condition, determining an abnormal behavior subgraph in the behavior relationship graph, where the behavior information of the one or more known abnormal nodes is abnormal; and based on the abnormal behavior subgraph, determining an abnormal node in the behavior relationship graph.

According to embodiments of the present disclosure, the present disclosure further provides a non-transitory computer-readable storage medium storing computer programs, where the computer programs may be configured to cause the computer to execute: obtaining behavior information, where the behavior information includes behavior information of at least two objects; constructing a behavior relationship graph according to the behavior information; based on one or more known abnormal nodes in the behavior relationship graph and a preset condition, determining an abnormal behavior subgraph in the behavior relationship graph, where the behavior information of the one or more known abnormal nodes is abnormal; and based on the abnormal behavior subgraph, determining an abnormal node in the behavior relationship graph.

According to embodiments of the present disclosure, the present disclosure further provides an electronic device and a readable storage medium.

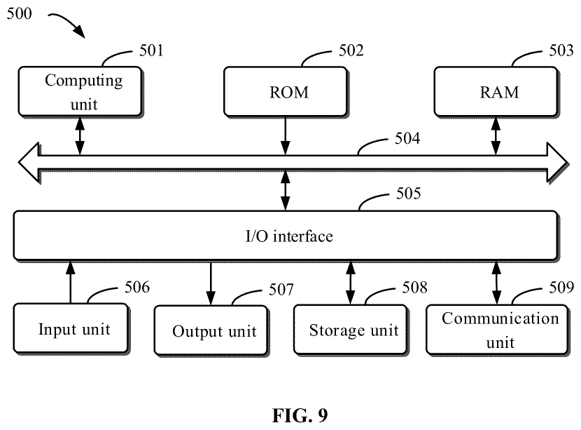

FIG. 9 illustrates a schematic block diagram of an exemplary electronic device 500 configured to implement embodiments of the present disclosure. The electronic device may be intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular phones, smart phones, wearable devices, and other similar computing devices. The parts, and corresponding connections, relationships and functions in the present disclosure may be merely exemplary and may be not intended to limit the implementation of the present disclosure described and/or claimed herein.

As shown in FIG. 9, the electronic device 500 may include a computing unit 501, which may perform various suitable operations and processes according to a computer program stored in a read-only memory (ROM) 502 or a computer program loaded from a storage unit 508 into a random-access memory (RAM) 503. In the RAM 503, a variety of programs and data required for the operation of the electronic device 500 may also be stored. The computing unit 501, the ROM 502, and the RAM 503 may be connected to each other via a bus 504. An input/output (I/O) interface 505 may be also connected to the bus 504.

Multiple parts in the electronic device 500 may be connected to the I/O interface 505, including an input unit 506, such as a keyboard, a mouse or the like; an output unit 507, such as various types of displays, speakers or the like; a storage unit 508, such as a disk, an optical disk or the like; and a communication unit 509, such as a network card, a modem, a wireless communication transceiver or the like. The communication unit 509 may allow the electronic device 500 to exchange information/data with other devices through a computer network, such as the Internet and/or various telecommunication networks.

The computing unit 501 may be various general and/or special processing components with processing and computing capabilities. Some examples of the computing unit 501 may include, but may be not limited to, a central processing unit (CPU), a graphics processing unit (GPU), various special artificial intelligence (AI) computing chips, various computing units for running machine learning model algorithms, digital signal processors (DSPs), and any suitable processors, controllers, microcontrollers and the like. The computing unit 501 may perform various methods and processes described above, such as the abnormal behavior detection method. For example, in some embodiments, the abnormal behavior detection method may be implemented as a computer software program, which may be tangibly contained in a machine-readable medium, such as a storage unit 508. In some embodiments, a part or all of the computer programs may be loaded and/or installed on the electronic device 500 via the ROM 502 and/or the communication unit 509. When the computer program is loaded into the RAM 503 and executed by the computing unit 501, one or more exemplary steps of the abnormal behavior detection method described above may be performed. Optionally, in other embodiments, the computing unit 501 may be configured to perform the abnormal behavior detection method in any other suitable manner (e.g., by means of firmware).

Various embodiments of the systems and techniques described in the present disclosure may be implemented in digital electronic circuit systems, integrated circuit systems, field programmable gate arrays (FPGAs), application specific integrated circuits (ASICs), application specific standard products (ASSPs), integrated systems on chips (SOCs), complex programmable logic devices (CPLDs), computer hardware, firmware, software, and/or combinations thereof. Above various embodiments may include being implemented in one or more computer programs that may be executed and/or interpreted on a programmable system which may include at least one programmable processor. The programmable processor may be a dedicated or general programmable processor, which may receive data and instructions from a storage system, at least one input apparatus, and at least one output apparatus; and transmit data and instructions to the storage system, the at least one input apparatus, and the at least one output apparatus.

The program code for implementing the method of the present disclosure may be written in any combination of one or more programming languages. Above program code may be provided to a processor or controller of a general-purpose computer, a special-purpose computer, or other programmable data processing device, such that when the program code is executed by the processor or controller, the functions/operations specified in the flowchart and/or block diagram may be implemented. The program code may be executed entirely on the machine, partially on the machine, partially on the machine as a stand-alone software package and partially on a remote machine, or entirely on a remote machine or server.

In the context of the present disclosure, a machine-readable medium may be a tangible medium containing or storing programs used by an instruction execution system, an apparatus, a device, or a combination thereof. A machine-readable medium may be a machine-readable signal medium or a machine-readable storage medium. A machine-readable medium may include, but may be not limited to, an electronic, magnetic, optical, electromagnetic, infrared, or semiconductor system, apparatus, device, or any suitable combination thereof. Moreover, the machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof.

To provide interaction with the user, the systems and techniques described in the present disclosure may be implemented on a computer. The computer may include a display apparatus (e.g., a CRT (cathode ray tube) or LCD (liquid crystal display) monitor) for displaying information to the user; and a keyboard and a pointing device (e.g., a mouse or track ball) through which the user may provide input to the computer. Other types of apparatuses may also be configured to provide interaction with the user. For example, the feedback provided to the user may be any form of sensory feedback (e.g., visual feedback, auditory feedback, or tactile feedback); and the input from the user may be received in any form (including acoustic input, voice input, or tactile input).

The systems and techniques described in the present disclosure may be implemented in a computing system including a backend component (e.g., as a data server), or a computing system including a middleware component (e.g., an application server), or a computing system including a frontend component (e.g., a user computer with a graphical user interface or a web browser through which the user may interact with implementation manners of the systems and techniques described in the present disclosure), or a computing system including any combination of backend components, middleware components, or frontend components. The components of the system may be interconnected by any form or medium of digital data communication (e.g., a communication network). Examples of communication networks may include a local region network (LAN), a wide region network (WAN), and the Internet.

The computer system may include a client and a server. The client and the server may be remote from each other and interact through a communication network. The relationship between the client and the server may be generated by computer programs running on corresponding computers and having a client-server relationship with each other. The server may be a cloud server, a server of a distributed system, or a server combined with a blockchain.

It should be understood that various forms of processes shown above may be configured to reorder, add or delete exemplary steps. For example, exemplary steps recorded in the present disclosure may be executed in parallel, sequentially or in different orders, as long as desired results of the technical solution disclosed in the present disclosure are achieved, which may not be limited in the present disclosure.

In addition, the terms “first” and “second” may be used only for descriptive purposes and cannot be understood as indicating or implying relative importance or implicitly indicating the number of technical features indicated. Therefore, the features defined as “first” and “second” may explicitly or implicitly include at least one of the features. In the description of the present disclosure, the meaning of “plurality” may be two or more, unless otherwise clearly and specifically defined.

The above may merely be embodiments of the present disclosure, but the protection scope of the present disclosure may not be limited thereto. Those skilled in the art may easily think of changes or substitutions within the technical scope disclosed in the present disclosure, which should be covered by the protection scope of the present disclosure. Therefore, the protection scope of the present disclosure should be subject to the protection scope of the claims.

What is claimed is:

1. An abnormal behavior detection method, comprising:
obtaining behavior information, wherein the behavior information includes behavior information of at least two objects;
constructing a behavior relationship graph according to the behavior information;
based on one or more known abnormal nodes in the behavior relationship graph and a preset condition, determining an abnormal behavior subgraph in the behavior relationship graph, wherein the behavior information of the one or more known abnormal nodes is abnormal; and
based on the abnormal behavior subgraph, determining an abnormal node in the behavior relationship graph.

2. The method according to claim 1, wherein constructing the behavior relationship graph according to the behavior information includes:
determining each object of the behavior information to be a node of the behavior relationship graph; and
connecting objects with an association relationship as an edge of the behavior relationship graph.

3. The method according to claim 2, wherein the preset condition includes:
in response to that a number of times, that a suspicious node in the behavior relationship graph is marked, satisfies a threshold, determining the suspicious node to be an abnormal node.

4. The method according to claim 3, wherein determining the suspicious node in the behavior relationship graph includes at least one of following:
determining a node, directly connected to a known abnormal node in the behavior relationship graph, to be the suspicious node; or
determining a node, directly connected to a plurality of suspicious nodes, also to be the suspicious node.

5. The method according to claim 4, wherein determining the abnormal behavior subgraph in the behavior relationship graph based on the one or more known abnormal nodes in the behavior relationship graph and the preset condition includes:
determining an abnormal node based on the preset condition;
determining the abnormal node and the one or more known abnormal nodes in the behavior relationship graph as intermediate nodes; and
according to the intermediate nodes, segmenting the behavior relationship graph to obtain the abnormal behavior subgraph in the behavior relationship graph.

6. The method according to claim 1, wherein determining the abnormal node in the behavior relationship graph based on the abnormal behavior subgraph includes:
determining a first feature vector of the abnormal behavior subgraph; and
selecting the abnormal node from the behavior relationship graph based on the first feature vector.

7. The method according to claim 6, wherein selecting the abnormal node from the behavior relationship graph based on the first feature vector includes:
using a suspicious node in the behavior relationship graph as a central node, segmenting the behavior relationship graph to obtain a plurality of suspicious subgraphs;
determining a second feature vector of each of the plurality of suspicious subgraphs;
determining similarity between the first feature vector and the second feature vector; and
determining a suspicious subgraph that satisfies a similarity threshold to be the abnormal behavior subgraph, wherein the suspicious node in the abnormal behavior subgraph is the abnormal node.

8. An electronic device, comprising:
a memory, configured to store a computer program; and
one or more processors, configured to, when the computer program is executed, perform:
obtaining behavior information, wherein the behavior information includes behavior information of at least two objects;
constructing a behavior relationship graph according to the behavior information;
based on one or more known abnormal nodes in the behavior relationship graph and a preset condition, determining an abnormal behavior subgraph in the behavior relationship graph, wherein the behavior information of the one or more known abnormal nodes is abnormal; and
based on the abnormal behavior subgraph, determining an abnormal node in the behavior relationship graph.

9. The electronic device according to claim 8, wherein for constructing the behavior relationship graph according to the behavior information, the one or more processors is configured to:
determine each object of the behavior information to be a node of the behavior relationship graph; and
connect objects with an association relationship as an edge of the behavior relationship graph.

10. The electronic device according to claim 9, wherein the preset condition includes:
in response to that a number of times, that a suspicious node in the behavior relationship graph is marked, satisfies a threshold, determining the suspicious node to be an abnormal node.

11. The electronic device according to claim 10, wherein for determining the suspicious node in the behavior relationship graph, the one or more processors is configured to perform at least one of following:
determining a node, directly connected to a known abnormal node in the behavior relationship graph, to be the suspicious node; or
determining a node, directly connected to a plurality of suspicious nodes, also to be the suspicious node.

12. The electronic device according to claim 11, wherein for determining the abnormal behavior subgraph in the behavior relationship graph based on the one or more known abnormal nodes in the behavior relationship graph and the preset condition, the one or more processors is configured to:
determine an abnormal node based on the preset condition;
determine the abnormal node and the one or more known abnormal nodes in the behavior relationship graph as intermediate nodes; and
according to the intermediate nodes, segment the behavior relationship graph to obtain the abnormal behavior subgraph in the behavior relationship graph.

13. The electronic device according to claim 8, wherein for determining the abnormal node in the behavior relationship graph based on the abnormal behavior subgraph, the one or more processors is configured to:
determine a first feature vector of the abnormal behavior subgraph; and
select the abnormal node from the behavior relationship graph based on the first feature vector.

14. The electronic device according to claim 13, wherein for selecting the abnormal node from the behavior relationship graph based on the first feature vector, the one or more processors is configured to:
using a suspicious node in the behavior relationship graph as a central node, segment the behavior relationship graph to obtain a plurality of suspicious subgraphs;
determine a second feature vector of each of the plurality of suspicious subgraphs;
determine similarity between the first feature vector and the second feature vector; and
determine a suspicious subgraph that satisfies a similarity threshold to be the abnormal behavior subgraph, wherein the suspicious node in the abnormal behavior subgraph is the abnormal node.

15. A non-transitory computer-readable storage medium, containing a computer program that when being executed, causes a processor to perform:
obtaining behavior information, wherein the behavior information includes behavior information of at least two objects;
constructing a behavior relationship graph according to the behavior information;
based on one or more known abnormal nodes in the behavior relationship graph and a preset condition, determining an abnormal behavior subgraph in the behavior relationship graph, wherein the behavior information of the one or more known abnormal nodes is abnormal; and
based on the abnormal behavior subgraph, determining an abnormal node in the behavior relationship graph.

16. The storage medium according to claim 15, wherein for constructing the behavior relationship graph according to the behavior information, the one or more processors is configured to:
determine each object of the behavior information to be a node of the behavior relationship graph; and
connect objects with an association relationship as an edge of the behavior relationship graph.

17. The storage medium according to claim 16, wherein the preset condition includes:
in response to that a number of times, that a suspicious node in the behavior relationship graph is marked, satisfies a threshold, determining the suspicious node to be an abnormal node.

18. The storage medium according to claim 17, wherein for determining the suspicious node in the behavior relationship graph, the one or more processors is configured to perform at least one of following:
determining a node, directly connected to a known abnormal node in the behavior relationship graph, to be the suspicious node; or
determining a node, directly connected to a plurality of suspicious nodes, also to be the suspicious node.

19. The storage medium according to claim 18, wherein for determining the abnormal behavior subgraph in the behavior relationship graph based on the one or more known abnormal nodes in the behavior relationship graph and the preset condition, the one or more processors is configured to:
determine an abnormal node based on the preset condition;
determine the abnormal node and the one or more known abnormal nodes in the behavior relationship graph as intermediate nodes; and
according to the intermediate nodes, segment the behavior relationship graph to obtain the abnormal behavior subgraph in the behavior relationship graph.

20. The storage medium according to claim 15, wherein for determining the abnormal node in the behavior relationship graph based on the abnormal behavior subgraph, the one or more processors is configured to:
determine a first feature vector of the abnormal behavior subgraph; and
select the abnormal node from the behavior relationship graph based on the first feature vector.
